(19) United States
(12) Patent Application Publication
(10) Pub. No.: US 2024/0338416 A1
(43) Pub. Date: Oct. 10, 2024

(54) Automatic data composition optimization

(71) Applicant: Publicis Groupe SA, Paris (FR)

(72) Inventors: Theodore Khoury, Dubai (AE); Ali Nehme, Dubai (AE); Atul Anand, Bengaluru, Karnataka (IN); Elias Milan, Dubai (AE)

(21) Appl. No.: 18/693,392

(22) PCT Filed: Sep. 21, 2022
(86) PCT No.: PCT/EP2022/076276

§ 371 Date: Mar. 19, 2024

(30) Foreign Application Priority Data
Sep. 21, 2021 (EP) 21198112.1

(51) Int. Cl. G06F 16/957; G06Q 30/0601

(52) U.S. Cl. CPC G06F 16/9577; G06Q 30/0643

(57) ABSTRACT

A method and a system for automatically optimizing a data composition can be configured to provide a plurality of data subsets, combine the data subsets to combined data, and analyze the combined data by variations of at least one data subset. In some aspects, the system and method include a plurality of nodes, wherein the analyzing of variations is performed at at least one node of a node system.

### FIELD

The present invention relates to a system and a method to automatically compose combined data comprising a plurality of data subsets. The combined data can comprise one or more images, videos, alpha numeric data etc. The combined data is optimized by training on the basis of user analytics of the sub datasets and any combination(s) thereof.

### BACKGROUND

In the internet, composed data is presented to users. Such composed data can comprise a plurality or even a larger number of sub datasets that individually and in combination can have an impact onto the perception of the user. It is impossible or at least difficult to determine and optimize the influence or perception of each data subset onto the user and how the data subsets in any combination influence the perception in a positive manner.

Several attempts have been made by a number of professional groups to improve user perception of combined data by data analysts, marketing specialists, designers, psychologists etc. As is well known and exercised for a long time, analyses have comprised user surveys, phone or in-person interviews, web and exit surveys, etc. This leads to a tedious and an expensive process and still targeting the appropriate user and obtaining the accurate information is often not possible.

However, the optimization is still done on a subjective level and has not been automatically conducted on a technical and objective basis.

US 2013 0 035 985 A1 is directed to a system and methods which enable modelling of end consumer interests based on online activity and producing e-commerce reports. The method includes scoring and classifying interests and preferences of consumers in relation to various items being offered as function of time and utilizing such scores to predict purchasing activity and revenue yield for n-dimensional combinations of interest for generation of consumer lists for target marketing and merchandising. The method also includes converse modelling of the performance and behavioural profile of items offered as a function of consumer activity.

### SUMMARY

In light of the above, it is an object of the present invention to overcome or at least alleviate the shortcomings of the prior art. More particularly, it is an object of the present invention to provide a system and a corresponding method to automatically optimize the perception of combined data, particularly in the internet and/or e-commerce space. The optimization can mean to make the combined data easier to understand, to provide a more positive perception, an easier identification or attraction of a subject that is defined by the combined data.

It is a further object of the present invention to provide a novel combination of existing methods of machine learning (supervised, unsupervised, semi-supervised) to automatically optimize data composition.

The present invention is particularly related to a method and a system for automatically optimizing a data composition. The system and the method can be configured to provide a plurality of data subsets, combine the data subsets to combined data and analyze the combined data by variations of at least one data subset.

According to another aspect of the invention, the system and method can comprise a plurality of nodes wherein the analyzing of variations is performed on the basis of analytics of at least one node of a node system. In particular, user activity can be measured, determined and/or benchmarked.

According to the present invention, the system and method initiate analyzing of variations that is performed at a plurality of nodes of a node system. The node system can be a network, such as the internet. These nodes can be accessed by users of the network by computers, handheld devices, TV sets etc.

The analyzing of variations can be performed by user activity at one or more nodes.

The present invention can further comprise a component for providing the combined data to a plurality of nodes.

The combined data provided to different nodes can comprise at least one different data composition with at least one different data subset.

The analyzing can be done on the basis of measuring user-related behavior data.

The user-related behavior data can comprise at least one of remaining time of the combined data on the node of the user, interaction with the combined data or data subsets by the user, qualified interaction, weighted interaction.

The analyzing of variations can be performed by analyzing and can comprise at least one of the following: clicking onto a data subset on screen; measuring and/or benchmarking the time of having a data subset visible or enlarged on a screen; triggering a purchasing process after having had a data subset visible or enlarged on a screen; and/or comparing and/or benchmarking the ratio of triggering a purchasing process between combined data with differing data subsets. Benchmarking in this context comprises comparing and/or ranking the combined data on the basis of user action intended.

The analyzing of variations can be performed in a differentiated manner regarding the time, the day, the week and/the time of the year. This can be particularly useful as user action or perception usually differs during the time of the day etc. Particularly when training by machine learning, the training data can take this into consideration and can, thus, provide a more robust and general result.

The data composition can comprise one or more pages of an internet platform. A plurality of pages can be ranked based on the analyzing.

The data composition can be stored and/or delivered by a server.

According to the present invention the system can further comprising an e-commerce platform with a plurality of nodes.

Further, the combined data can comprise variable data and/or wherein the data subsets comprise features. The variable data can comprise variable features, such as temporal and/or engineering features.

Alternatively or additionally, the combined data can comprise text data. The text data can comprise text features, such as trained embeddings, statistics and/or readability features.

The combined data can comprise image data. The image data can comprise image features, such as image quality, OCR (optical character recognition) and/or legibility and/or metadata features.

Moreover, the invention can comprise a rank modelling component configured to analyze and/or model and/or benchmark the impact of the combined data with the data subsets.

The impact can be analyzed on the basis of the features.

Further, the system and method can comprise a modelling component configured to model optimized combined data.

Further, it can comprise a synthetic product creation component configured to create synthetic products on the basis the optimized combined data.

Furthermore, the system and method can comprise a rank prediction component configured to predict a rank of the combined data in a pool of combined data.

Moreover, a service component can be provided, such as a storage service component and/or a metrics service component and/or a sales service component.

Also, an AI component can be provided that is configured to train the processing component. The AI component can be configured to train the processing component in unsupervised fashion by variations of at least one data subset and analyzing the user activity as a basis for training data.

Moreover, a synthesizing component can be arranged for synthesizing the combined data on the basis of the variations of the at least one data subset.

The invention also comprises a computer program product configured to perform the method as described herein.

The automatically analyzing the combined data can be performed by variations of at least two data subsets by a processing component. This can be an integral computational component or can comprise a plurality of computations components that can further be arranged remotely. The processing component can further comprise a plurality of computational components.

The data subsets can comprise one or more of primary images, secondary images, rich content, title text, bullet points and/or product description. The data subsets can comprise one or more of pricing data, such as one or more of a product price, coupons provided and/or sales discounts. The data subsets can additionally or alternatively comprise one or more of product details, such as subscribe and save options, product variations, tags, reviews, questions, comments, seller information and/or product bundles etc.

The method comprises the step of deriving node data from at least one remote and/or at least one local database. Also, the data can be derived from a plurality of databases. The database can be an existing database available on the internet. The database can also be configured to be chosen on the basis of a user preference. The node data being affiliated to a plurality of nodes. The choosing of the database can also be done in an automated manner according to pre-set and/or automatically generated criteria.

Further, the method comprises transferring the node data or some part of the node data into a local storage.

In summary, we can define the problem for consumer brands as two distinct problems:

Identify the variables that have the most impact on the rank of the product

To overcome this problem, we start by extracting all the variables of the best-selling products within a subcategory across a period of time, which would include all the variables mentioned above. Following this step, significant feature engineering takes places to extract additional value from these features that could capture customer preferences. Once the data is prepared, we train a model to estimate the rank of a product given the extracted/prepared features.

The second step of the approach is identifying the importance of individual variables in influencing the rank of the product. Although most machine learning models provide a feature importance function within their packages, this mainly provides an understanding of the importance of these features on the model itself, not on real data.

To overcome this problem, we implement approach to calculate the fair contribution of each individual feature to the rank of the product using an interventional approach on the real data. This allows us to estimate how each individual feature is contributing to the rank of a certain product. This solves the first problem for brands in managing their online presence by allowing them to identify the most impactful variables that are influencing their product ranks and the average impact on rank this variable could have.

Once the first problem is solved, the second problem becomes critical since identifying the importance of individual variables does not let brands know what these variables should be to maximize their rank. One approach would be to utilize different values of these features in the predictive model trained earlier to find which value provides the best predicted rank.

Given the number of features that are used to train the model, and the fact that you would need not only features regarding the product itself, but non-controllable factors as well that can influence the rank of a product i.e. the feature values for the competing products, this quickly becomes a NP hard problem and would not be solvable.

To overcome this issue, we implement a reverse optimization approach on the previously trained model by utilizing the prediction of the rank as the cost function of the algorithm and the feature values as the function parameters. This step requires detailed manipulation of the search space for the algorithm in order to define which products we want to optimize against, and which features we want to find optimal values for.

This allows us to solve the second problem mentioned above, by estimating the optimal values of individual features that would have the most beneficial impact on the rank of a product.

In some embodiments, the node may comprise a communication endpoint, an active electronic device which can further be capable of creating, receiving, or transmitting node data. In some embodiments the node data may be structured before transferring it into the local storage. The structuring may comprise formatting the node data to enable efficient access and modifications. In some embodiments a hash function can be applied to the node data to facilitate node privacy. The node data may be the stored, existing data on the node or the remote database. The node data may also be generated automatically in some embodiments. For example, if the database comprises a group of websites, the node data may be generated automatically by using sitemap protocol.

The node data may be then transferred to a local storage automatically. In some embodiments only part of node data can be transferred to the local storage. The local storage may be a web storage in some embodiments. In some further embodiments, it may be a cloud storing the node data. In some embodiments, node data may comprise content data. The content data may be the data generated by at least one node on at least one of the remote or local databases.

In some embodiments the remotely and/or locally stored node data is pulled by the local storage by calling the databases randomly. The database may be called randomly to disable tracing the route. In a preferred embodiment node data from the database to the local storage may be transferred through a single connection to save the time and to avoid repeatedly open and close of a new connection.

In some embodiments the node data may be derived from a plurality of databases. The databases may be remote in some embodiments. The databases may be local in some embodiments. In some embodiments the node may be anonymized before sending the node data to the local storage. The anonymization may comprise an automatically generated identification node data, preferably via hash function.

In a further embodiment the database may be automatically approached by a data receiving component. The data receiving component may be configured to directly download node data from the database/s. The download in some embodiments may be performed over the internet. The data receiving component may approach the database(s) randomly.

In some embodiments the node data may comprise a plurality of parameters, each parameter may be comprising information about a node attribute. For example, parameters may be the content data from a social media platform, or one parameter may be the timestamp automatically pulled from the node. In some embodiments the node may be entering the node data directly in the local storage.

In a further preferred embodiment, the node data may be the text data generated by the at least one node from at least one database. In a further embodiment the method may comprise the step of automatically matching the at least one parameter with the at least one node. The node data may be matched with more than one node in some embodiments. In other embodiments each matching between the node data and the node may comprise an associated automatically generated matching score. The matching score may be a measure of similarity between the node data and the matched node. In some embodiments, the method may be automatically generating a quality score. The quality score may comprise a measure of a statistical difference between the two or more nodes. The quality score may comprise a perplexity score of the two or more nodes.

In some embodiments the method may comprise a scheduled and/or non-scheduled monitoring of the at least one node. The method may further comprise automatically generating a new matching score with a second node data associated with the monitored node. In some embodiments the method may learn with every matching and add a new node to the node data based on the monitoring. In some embodiment the association may be a symmetric association, i.e., the node may also be associated with the node data.

In some embodiments the method may comprise incrementally feeding further nodes and node data from an existing database. The database may be a social media database or a plurality of social media databases.

The invention is further described with the following numbered embodiments.

Below, system embodiments will be discussed. These embodiments are abbreviated by the letter “S” followed by a number. Whenever reference is herein made to “system embodiments”, these embodiments are meant.
S1. A system for automatically optimizing a data composition, the system being configured to:
   a. provide a plurality of data subsets;
   b. combine data the data subsets to combined data (10-13); and
   C. analyze the combined data by variations of at least one data subset.
S2. System according to the preceding system embodiment comprising a plurality of nodes (20-23) wherein the analyzing of variations is performed at at least one node (20-23) of a node system.
S3. System according to any one of the preceding system embodiments wherein the analyzing of variations is performed at a plurality of nodes (20-23) of a node system.
S4. System according to the preceding system embodiment wherein the analyzing of variations is performed by analyzing user activity at one or more nodes (20-23).
S5. System according to the preceding system embodiment wherein the analyzing of variations is performed by analyzing user behavior at one or more nodes (20-23).
S6. System according to any of the two preceding system embodiments wherein the analyzing of variations is performed by analyzing can comprise at least one of the following:
   a. Clicking onto a data subset on screen;
   b. Measuring and/or benchmarking the time of having a data subset visible or enlarged on a screen;
   c. Triggering a purchasing process after having had a data subset visible or enlarged on a screen; and/or
   d. Comparing and/or benchmarking the ratio of triggering a purchasing process between combined data with differing data subsets.
S7. System according to any of the preceding system embodiments wherein the analyzing of variations is performed in a differentiated manner regarding the time.
S8. System according to any of the preceding system embodiments wherein the analyzing of variations is performed in a differentiated manner regarding the time of the day.
S9. System according to any of the preceding system embodiments wherein the analyzing of variations is performed in a differentiated manner regarding the time of the week.
S10. System according to any of the preceding system embodiments wherein the analyzing of variations is performed in a differentiated manner regarding the time of the year.
S11. System according to any of the preceding system embodiments with the further step of providing the combined data to a plurality of nodes (20-23).
S12. System according to the preceding system embodiment wherein the combined data provided to different nodes (20-23) comprises at least one different data composition (10-13) with at least one different data subset.
S13. System according to the preceding system embodiment wherein the analyzing is done on the basis of measuring and/or benchmarking user-related behavior data.
S14. System according to the preceding system embodiment wherein the user-related behavior data comprises at least one of remaining time of the combined data on the node of the user, interaction with the combined data or data subsets by the user, qualified interaction, weighted interaction.
S15. System according to any of the preceding system embodiments wherein the data composition comprises one or more pages of an internet platform.
S16. System according to the preceding system embodiment where a plurality of pages is ranked based on the analyzing.
S17. System according to any of the preceding system embodiments wherein the data composition (10-13) is stored and/or delivered by a server (2).
S18. System according to any of the preceding system embodiments wherein the automatically analyzing the combined data by variations of at least two data subsets is performed by a processing component (1).
S19. System according to the preceding system embodiment where in the processing component (1) is an integral computational component.
S20. System according to the preceding system embodiment where in the processing component (1) comprises a plurality of computational components.
S21. System according to any of the preceding system embodiments wherein the data subsets can comprise one or more of primary images, secondary images, rich content, title text, bullet points and/or product description.
S22. System according to any of the preceding system embodiments wherein the data subsets can comprise one or more of pricing data, such as one or more of a product price, coupons provided and/or sales discounts.
S23. System according to any of the preceding system embodiments wherein the data subsets can comprise one or more of product details, such as subscribe and save options, product variations, tags, reviews, questions, comments, seller information and/or product bundles etc.
S24. System according to any of the preceding system embodiments further comprising an e-commerce platform with a plurality of nodes (20-23).
S25. System according to any of the preceding system embodiments wherein the combined data comprises variable data.
S26. System according to any of the preceding system embodiments wherein the data subsets comprise features.
S27. System according to the preceding system embodiment wherein the variable data comprises variable features, such as temporal and/or engineering features.
S28. System according to any of the preceding system embodiments wherein the combined data comprises text data.
S29. System according to the preceding system embodiment wherein the text data comprises text features, such as statistics and/or readability features.
S30. System according to any of the preceding system embodiments wherein the combined data comprises image data.
S31. System according to the preceding system embodiment wherein the image data comprises image features, such as OCR and/or legibility and/or metadata features.
S32. System according to any of the preceding system embodiments further comprising a rank modelling component configured to analyze and/or model and/or benchmark the impact of the combined data with the data subsets.
S33. System according to the preceding system embodiment wherein the impact is analyzed on the basis of the features.
S34. System according to the preceding system embodiment wherein the impact is analyzed on the basis of the features.
S35. System according to any of the preceding system embodiments further comprising a modelling component configured to model optimized combined data.
S36. System according to any of the preceding system embodiments further comprising a synthetic product creation component configured to create synthetic products on the basis the optimized combined data.
S37. System according to any of the preceding system embodiments further comprising a rank prediction component configured to predict a rank of the combined data in a pool of combined data.
S38. System according to any of the preceding system embodiments further comprising service components, such as a storage service component and/or a metrics service component and/or a sales service component.
S39. System according to any of the preceding system embodiments further comprising an AI component configured to train the processing component (1).
S40. System according to the preceding system embodiment wherein the AI component is configured to train the processing component (1) in unsupervised fashion by variations of at least one data subset and analyzing the user activity.
S41. System according to any of the preceding system embodiments further comprising a synthesizing component for synthesizing the combined data on the basis of the variations of the at least one data subset.

Below, method embodiments will be discussed. These embodiments are abbreviated by the letter “M” followed by a number. Whenever reference is herein made to “method embodiments”, these embodiments are meant.
M1. A method for automatically optimizing data composition:
   a. Providing a plurality of data subsets;
   b. Combining data subsets to combined data (10-13);
   c. Automatically analyzing the combined data by variations of at least two data subsets.
M2. Method according to the preceding method embodiment wherein the analyzing of variations is performed at a node (20-23) of a node system.
M3. Method according to any one of the preceding method embodiments wherein the analyzing of variations is performed at a plurality of nodes (20-23) of a node system.
M4. Method according to the preceding method embodiment wherein the analyzing of variations is performed by analyzing user activity at one or more nodes (20-23).
M5. Method according to the preceding method embodiment wherein the analyzing of variations is performed by analyzing user behavior at one or more nodes (20-23).
M6. Method according to any of the preceding method embodiments with the further step of providing the combined data to a plurality of nodes (20-23).
M7. Method according to any of the two preceding method embodiments wherein the analyzing of variations is performed by analyzing can comprise at least one of the following:
   a. Clicking onto a data subset on screen;
   b. Measuring and/or benchmarking the time of having a data subset visible or enlarged on a screen;
   c. Triggering a purchasing process after having had a data subset visible or enlarged on a screen; and/or
   d. Comparing and/or benchmarking the ratio of triggering a purchasing process between combined data with differing data subsets.
M8. Method according to any of the preceding method embodiments wherein the analyzing of variations is performed in a differentiated manner regarding the time.
M9. Method according to any of the preceding method embodiments wherein the analyzing of variations is performed in a differentiated manner regarding the time of the day.
M10. Method according to any of the preceding method embodiments wherein the analyzing of variations is performed in a differentiated manner regarding the time of the week.
M11. Method according to any of the preceding method embodiments wherein the analyzing of variations is performed in a differentiated manner regarding the time of the year.
M12. Method according to the preceding method embodiment wherein the combined data provided to different nodes (20-23) comprises at least one different data composition (10-13) with at least one different data subset.
M13. Method according to the preceding method embodiment wherein the analyzing is done on the basis of measuring user-related behavior data.
M14. Method according to the preceding method embodiment wherein the user-related behavior data comprises at least one of remaining time of the combined data on the node of the user, interaction with the combined data or data subsets by the user, qualified interaction, weighted interaction.
M15. Method according to any of the preceding method embodiments wherein the data composition comprises one or more pages of an internet platform.
M16. Method according to the preceding method embodiment where a plurality of pages are ranked based on the analyzing.
M17. Method according to any of the preceding method embodiments wherein the data composition (10-13) is stored and/or delivered by a server (2).
M18. Method according to any of the preceding method embodiments wherein the automatically analyzing the combined data by variations of at least two data subsets is performed by a processing component (1).
M19. Method according to the preceding method embodiment where in the processing component (1) is an integral computational component.
M20. Method according to the preceding method embodiment where in the processing component (1) comprises a plurality of computational components.
M21. Method according to any of the preceding method embodiments wherein the data subsets can comprise one or more of primary images, secondary images, rich content, title text, bullet points and/or product description.
M22. Method according to any of the preceding method embodiments wherein the data subsets can comprise one or more of pricing data, such as one or more of a product price, coupons provided and/or sales discounts.
M23. Method according to any of the preceding method embodiments wherein the data subsets can comprise one or more of product details, such as subscribe and save options, product variations, tags, reviews, questions, comments, seller information and/or product bundles etc.
M24. Method according to any of the preceding method embodiments further comprising an e-commerce platform with a plurality of nodes (20-23).
M25. Method according to any of the preceding method embodiments wherein the combined data comprises variable data.
M26. Method according to any of the preceding method embodiments wherein the data subsets comprise features.
M27. Method according to the preceding method embodiment wherein the variable data comprises variable features, such as temporal and/or engineering features.
M28. Method according to any of the preceding method embodiments wherein the combined data comprises text data.
M29. Method according to the preceding method embodiment wherein the text data comprises text features, such as statistics and/or readability features.
M30. Method according to any of the preceding method embodiments wherein the combined data comprises image data.
M31. Method according to the preceding method embodiment wherein the image data comprises image features, such as OCR and/or legibility and/pr metadata features.
M32. Method according to any of the preceding method embodiments further comprising a rank modelling component configured to analyze and/or model and/or benchmark the impact of the combined data with the data subsets.
M33. Method according to the preceding method embodiment wherein the impact is analyzed on the basis of the features.
M34. Method according to the preceding method embodiment wherein the impact is analyzed on the basis of the features.
M35. Method according to any of the preceding method embodiments further comprising a modelling component configured to model optimized combined data.
M36. Method according to any of the preceding method embodiments further comprising a synthetic product creation component configured to create synthetic products on the basis the optimized combined data.
M37. Method according to any of the preceding method embodiments further comprising a rank prediction component configured to predict a rank of the combined data in a pool of combined data.
M38. Method according to any of the preceding method embodiments further comprising service components, such as a storage service component and/or a metrics service component and/or a sales service component.
M39. Method according to any of the preceding method embodiments further comprising an AI component configured to train the processing component (1).
M40. Method according to the preceding method embodiment wherein the AI component is configured to train the processing component (1) in unsupervised fashion by variations of at least one data subset and analyzing the user activity.
M41. Method according to any of the preceding method embodiments further comprising a synthesizing component for synthesizing the combined data on the basis of the variations of the at least one data subset.

Below, use embodiments will be discussed. These embodiments are abbreviated by the letter “U” followed by a number. Whenever reference is herein made to “use embodiments”, these embodiments are meant.
U1. Use of the system according to any of the preceding system embodiments for carrying out the method according to any of the preceding method embodiments.
U2. Use of the system according to any of the preceding embodiments for optimizing data compositions.

Below, program embodiments will be discussed. These embodiments are abbreviated by the letter “P” followed by a number. Whenever reference is herein made to “program embodiments”, these embodiments are meant.
P1. A computer program product comprising instructions, which, when the program is executed on a computer causes the computer to perform the method steps according to any of the preceding method embodiments.
P2. A computer program product comprising instructions, which, when the program is executed by a combination of a server and a node, cause the server and the node to perform the method steps according to any of the preceding method embodiments.
P3. A computer program product comprising instructions, which, when the program is executed by a server, cause the server to perform the method steps according to any of the preceding method embodiments.
P4. A computer program product comprising instructions, which, when the program is executed by a processing component, cause the processing component to perform the method steps according to any of the preceding method embodiments.

The present invention will now be described with reference to the accompanying drawings, which illustrate embodiments of the invention. These embodiments should only exemplify, but not limit, the present invention.

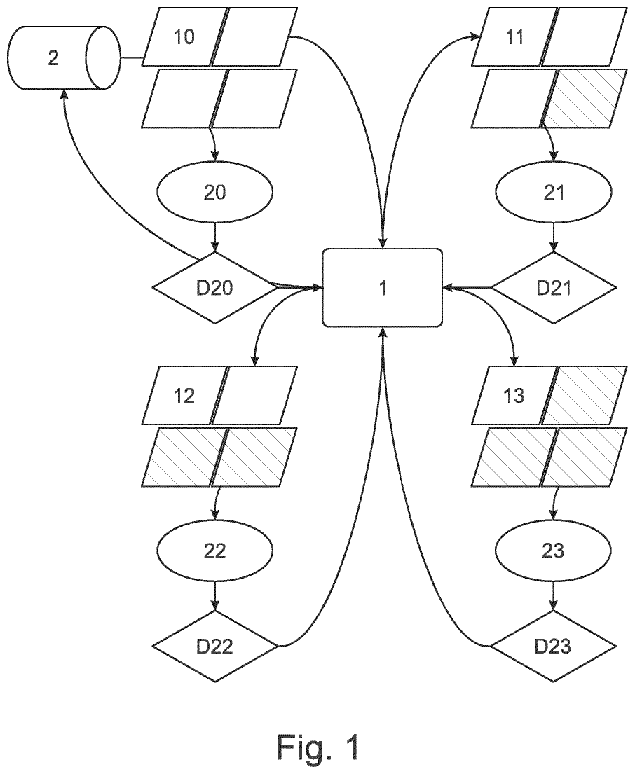

FIG. 1 schematically depicts an embodiment of a system, a method and a workflow in accordance with the present invention.

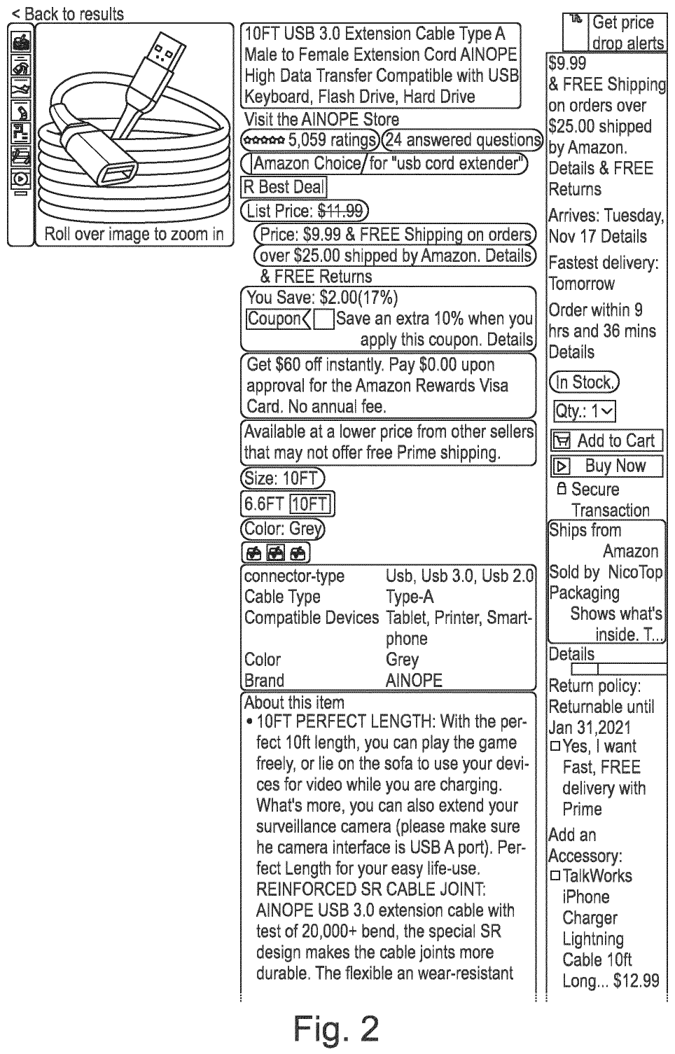

FIG. 2 constitutes a specific example of the data composition with a large number or data subsets.

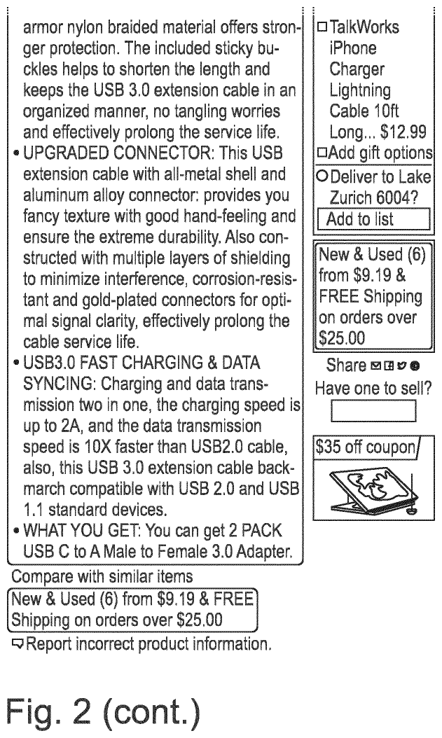

FIG. 3 schematically depicts a flow of data in the system and method according to the present invention.

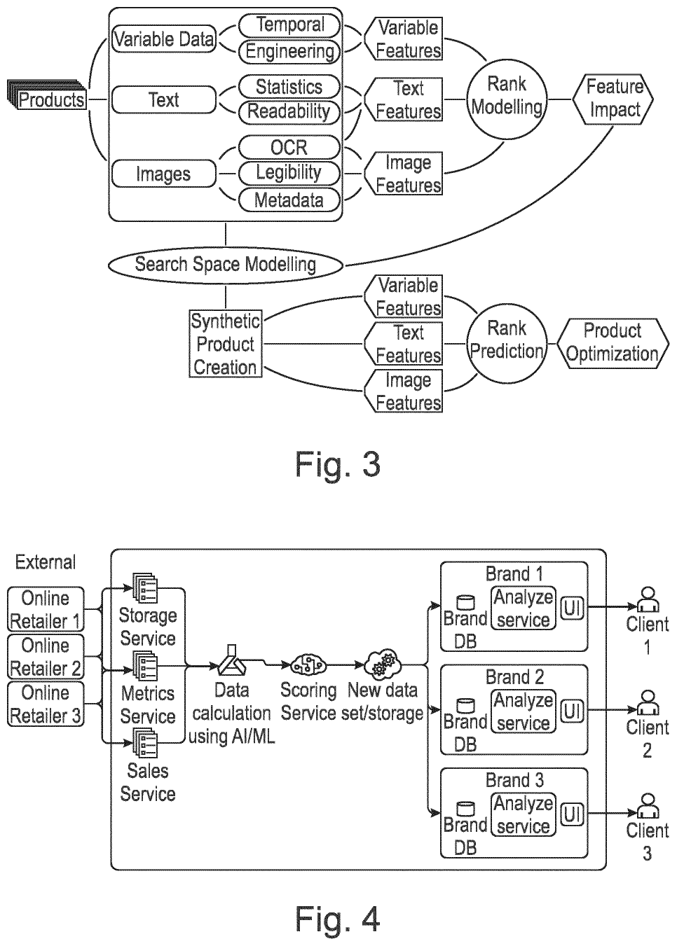

FIG. 4 exemplifies an architecture of servers, processing components and nodes in line with the present invention.

It is noted that not all the drawings carry all the reference signs. Instead, in some of the drawings, some of the reference signs have been omitted for sake of brevity and simplicity of illustration. Embodiments of the present invention will now be described with reference to the accompanying drawings.

FIG. 1 schematically depicts an embodiment of a method and a respective system for automatically optimizing data composition in accordance with the present invention.

As mentioned before the data composition can comprise the same kind of data and/or different kind of data, such as image data and/or text data and/or alpha numerical data etc. They interact and trigger different reactions at nodes and/or user at the nodes taking notice of the data. The data can be shown in a specific format configured for the node(s) addressed. The node(s) can supply the data in form of visually perceivable form, such as on a monitor of any kind of device, such as a handheld, computer etc.

A database or server 2 is providing a number of data subsets to form combined data 10. In the example shown, the combined data 10 comprises 4 data subsets. This is an example only. It can comprise less but in practice will often comprise more or much more data subsets.

A processing component 1 can modify the combined data 10 to form modified combined data 11. In FIG. 1 one of the data subsets is shown in a different grey level which constitutes an example only.

Both combined data 10 and 11, differing from each other, are delivered to nodes 20 and 21, respectively. This can be done at the same time or at different times. They can also be delivered to the same node. As mentioned, the nodes can be configured to only read the data in machine format. It is preferred that the node is configured to show the data in visualized form, such as on a monitor. A user may take notice of the composed data comprising the plurality of data subsets and can react to it or cannot react to it. A reaction or non-reaction is noticed and analyzed. Particularly, in case a user at the node is activating certain subset data this is analyzed. One or more of the subset data may allow the start of a video or any other kind of presentation. This can be noticed and can mean that this subset data is attractive to the user. In case the user further watches the video to the end or breaks up watching before the end this can also be analyzed. Particularly, in case a number of users break up at the same or a similar point of the video this can mean that at this time the video should be amended, shortened etc.

Anyhow, in the example shown the combined data 10 is then evaluated by node 20 in a decision component D20. In the example shown combined data 10 is not further considered or disregarded. This is then fed into the processing component 1 and analyzed accordingly.

On the other hand, combined data 11 having been modified by processing component 1 is considered by node 21 and considered further. This can be a decision to make use of combined data 11 by the node 21, by activating a purchasing trigger signal, any further use of the combined data 11 or a product represented by combined data 11. Also, a consideration of one of the data subsets being part of the combined data 11, such as a click onto that data subset, is noted by the processing component 1. This can further comprise not just the fact that the data subset has been considered but also the time of consideration, the kind of consideration etc. and/or any combination thereof.

In the processing component, the difference of consideration of the combined data 10 and 11 is then analyzed.

The processing component 1 can modify the combined data 10 and/or 11 further. This modification can also be done by another component and/or be done remotely and/or by the processing component 1. In the example shown, further modified combined data 12 and 13 are generated, respectively. They are provided to one or more further node(s) and undergo active and/or inactive judgement or analysis. The reaction by the node(s) 22 and 23 is then further analyzed by processing component.

The analysis can also take into consideration the time, location, modification etc. of the combined data and the respective data subsets.

All that is then processed in order to further optimize the data subsets, their composition and the combined data.

At some point, the processing component can store the findings at the server 2. This can be the favorite composed data to be submitted to one or more nodes next.

FIG. 2 is exemplifying composed data on a screen or monitor with a large number of data subsets of different nature. Without mentioning all the data subsets, some prominent ones are mentioned. There is a photo constituting a product at offer. To its left there is shown some alternative photos that can be clicked and enlarged by a node or a user at the node. The last one is a video that can be started and will be displayed at the location of the enlarge photo.

To the right, a larger number of other relevant data subsets such as a price, the stock availability, product color options available, comments of users being tracked etc. This is known. However, the present invention is automatically modifying the arrangement of the data subsets, their shape, their content, their proportion, their arrangement to each other etc. and is then analyzing the reaction to this. In case of a positive reaction, no or hardly or very few modifications are triggered, in case of a negative reaction, more modifications will be initiated.

According to FIG. 3, a composed data corresponding and/or specifying one or more products is shown to be composed by different data subsets, such as an image data subset, a text data subset, and/or a variable data subset. This is an example only, and the data subsets can comprise less and particularly more as well as any combination thereof.

The variable data subset can be characterized by a number of variable features that can comprise temporal features and/or engineering features etc. Engineering features can be any features relevant to the technical interaction, operability, computation etc. of the combined data and/or any data subset.

The text data subset can comprise statistics features, readability features etc. The statistics features can comprise the number of product(s) available, grades for the quality or popularity etc. The readability features can comprise the fonts information, the size(s) of the text, the overall layout etc.

The image features can comprise OCR information, legibility features and/or any metadata. This is an example only and the data can also comprise controlling data and/or any kind of technically relevant data or data subsets.

The existing combined data can be benchmarked, e.g., by a rank determination or modelling. This can be done in relation to other combined data on a platform, such as an e-commerce platform. The ranking or benchmarking can be determined by analyzing the impact of features. This can be determined by analyzing the impact of individual features or a group of features. Node information or data representing user action or behavior can be analyzed.

The data space, such as a search space in the internet, can be modelled by creating a synthetic model with the same feature structure as mentioned before, namely with variable features, text features and image features etc. or any combination thereof.

On this basis and in concert with the rank modelling a rank prediction can be established with a product optimization or combined data optimization representing a product or a product determination.

FIG. 4 exemplifies the technical architecture of an e-commerce platform. A number of online retailer or better combined data of products offered by them is fed into several service stations, such as a storage service for storing the combined data, a metrics service for handling metric information associated with the combined data and/or the data subsets. Additionally a sales service can be provided computing and handling the sales and payment process.

The combined data is then processed, preferably by using an AI or ML mode as described before, and optimized accordingly. A new data set/storage can then be automatically created and provided to the nodes or graphical user interfaces and can be provided in sorted fashion, such as sorted according to brands and their respective products.

Reference numbers and letters appearing between parentheses in the claims, identifying features described in the embodiments and illustrated in the accompanying drawings, are provided as an aid to the reader as an exemplification of the matter claimed. The inclusion of such reference numbers and letters is not to be interpreted as placing any limitations on the scope of the claims.

The term “at least one of a first option and a second option” is intended to mean the first option or the second option or the first option and the second option.

Whenever a relative term, such as “about”, “substantially” or “approximately” is used in this specification, such a term should also be construed to also include the exact term.

That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1-20. (canceled)

21. A system for automatically optimizing a data composition, the system being configured to:
provide a plurality of data subsets;
combine the data subsets to combined data; and
analyze the combined data by variations of at least one data subset.

22. The system according to claim 21, comprising a plurality of nodes, wherein the analyzing is performed at at least one node of a node system.

23. The system according to claim 21, wherein the analyzing is performed at a plurality of nodes of a node system.

24. The system according to claim 23, wherein the analyzing is performed by user activity at one or more nodes.

25. The system according to claim 21, wherein the system is further configured to provide the combined data to a plurality of nodes.

26. The system according to claim 25, wherein the combined data provided to the plurality of nodes comprises at least one different data composition with at least one different data subset.

27. The system according to claim 26, wherein the analyzing is performed on the basis of measuring user-related behavior data.

28. The system according to claim 27, wherein the user-related behavior data comprises at least one of remaining time of the combined data on the node of the user, interaction with the combined data or data subsets by the user, qualified interaction, or weighted interaction.

29. The system according to claim 21, wherein the data composition comprises one or more pages of an internet platform.

30. The system according to claim 29, where a plurality of pages are ranked based on the analyzing.

31. A method for automatically optimizing data composition, comprising:
providing a plurality of data subsets;
combining the data subsets to combined data; and
automatically analyzing the combined data by variations of at least two data subsets.

32. The method according to claim 31, wherein the analyzing is performed at a node of a node system.

33. The method according to claim 31, wherein the analyzing is performed at a plurality of nodes of a node system.

34. The method according to claim 33, wherein the analyzing is performed by user activity at one or more nodes.

35. The method according to claim 31, further comprising providing the combined data to a plurality of nodes.

36. The method according to claim 35, wherein the combined data provided to the plurality of nodes comprises at least one different data composition with at least one different data subset.

37. The method according to claim 36, wherein the analyzing is performed on the basis of measuring user-related behavior data.

38. The method according to claim 37, wherein the user-related behavior data comprises at least one of remaining time of the combined data on the node of the user, interaction with the combined data or data subsets by the user, qualified interaction, or weighted interaction.

39. The method according to claim 31, wherein the data composition comprises one or more pages of an internet platform.

40. The method according to claim 39, wherein a plurality of pages are ranked based on the analyzing.
